(19) United States
(12) Patent Application Publication
(10) Pub. No.: US 2004/0192145 A1
(43) Pub. Date: Sep. 30, 2004

(54) Non-woven sheet material for building construction

(76) Inventors: Richard Theoret, Montreal (CA); Alain Poirier, St-Luc (CA)

Correspondence Address: OGILVY RENAULT, 1981 MCGILL COLLEGE AVENUE, SUITE 1600, MONTREAL, QC, H3A2Y3, CA

(21) Appl. No.: 10/795,238

(22) Filed: Mar. 9, 2004

(30) Foreign Application Priority Data
Mar. 10, 2003 (CA) 2,421,458

(51) Int. Cl. B32B 27/04

(52) U.S. Cl. 442/394; 442/149

(57) ABSTRACT

A non-woven sheet material for use in building construction and having acoustical thermal and waterproof properties is described. The sheet material comprises a non-woven felt having a polymeric film secured over a surface thereof. The polymeric film has an outer aluminized reflective surface coating adhered thereto. The sheet material has a weight density in the range of from about 30 to 1500 g/m² and a homogeneous mechanical integrity resistance to fragmentation by the application of traction forces applied thereto during its intended use. The sheet material is capable of being used with the outer aluminum reflective surface facing upwardly or downwardly of an enclosure space to provide acoustical and/or thermal insulation to the space and to provide an impervious barrier.

### FIELD OF THE INVENTION

The present invention relates to a non-woven sheet material for use in building construction and wherein the material has acoustical, thermal and waterproof properties and is provided with an outer aluminized reflective surface coating, and wherein when in use the sheet material can be installed with the aluminized reflective coating facing inwardly or outwardly of an enclosure space.

### BACKGROUND OF THE INVENTION

Reference is made to my earlier U.S. Pat. No. 6,514,889 which relates to a sound and thermal insulating non-woven synthetic sheet material which may also be used in building construction. Various sound and thermally insulating materials are used in the building construction industry but most of these utilize rubberized materials or cork. Also, most of these materials cannot provide composite properties such as acoustical, thermal, vapor barrier and reflectivity, all integral in a single structure. Further, these materials are difficult to install and are costly to fabricate. Some disadvantages of such materials are that they are multilayered and often the layers detach along layered surfaces where they are glued or heat bonded.

It is desirable now to insulate residential dwellings and office buildings to provide better sound, thermal and waterproof insulation. Occupants of such buildings are more and more exposed to sounds by a multitude of environmental noise generating sources which are very distractive and stressful. In order to enhance the environment of the occupants of these buildings and offices, new building codes have been applied by federal agencies. These codes place a restriction on the intensity of sounds to be generated in an occupied environment. Also, with increasing fuel costs, it is desirable to preserve as much energy as possible and therefore to provide environments which are well thermally insulated while maintaining a high sound absorption performance and providing a good vapor barrier to control humidity.

### SUMMARY OF THE INVENTION

It is a feature of the present invention to provide a non-woven sheet material having acoustical, thermal and waterproof properties to provide for the construction of building structures with existing federal building codes and wherein the sheet material is easy to install and has a multitude of applications.

Another feature of the present invention is to provide a non-woven sheet material for use in building construction and having acoustical, thermal and waterproof properties and wherein the non-woven sheet material has an aluminized reflective surface which is provided with an adhesive surface protected by a peel-off sheet to permit easy application of the non-woven sheet material to various objects and further wherein the non-woven sheet material has a homogeneous mechanical integrity resistance to fragmentation by the application of traction forces applied thereto.

According to another feature of the present invention there is provided a method of fabricating a non-woven sheet material for use in building construction and having acoustical, thermal and waterproof properties and with a surface thereof being an aluminized reflective surface having heat reflective and vapor barrier properties.

According to the above features, and from a broad aspect there is provide a non-woven sheet material for use in building construction and wherein the material has acoustical, thermal and waterproof properties. The sheet material comprises a non-woven felt having a polymeric film secured over a surface thereof. The polymeric film has an outer aluminized reflective surface coating adhered thereto. The sheet material has a weight density in the range of from about 30 to 1500 g/m² and a homogeneous mechanical integrity resistance to fragmentation by the application of traction forces applied thereto during its intended use. The sheet material is capable of being used with the outer aluminized reflective surface facing inwardly or outwardly of an enclosure space to provide acoustical and/or thermal insulation to the space and to further provide an impervious barrier to humidity.

According to a further broad aspect of the present invention there is provided a method of fabricating a non-woven sheet material for use in building constructions and having acoustical, thermal and waterproof properties. The method comprises needle punching fibrous material to form a non-woven felt sheet. The felt sheet is transported in a pressing gap under a heated calender roll. A polymeric film, having an outer aluminized reflective surface coating, is fed in the pressing gap over a top surface of the non-woven felt with the aluminized reflective surface in contact with the calender roll to heat fuse the polymeric film over the top surface of the non-woven felt.

### BRIEF DESCRIPTION OF THE DRAWINGS

A preferred embodiment of the present invention will now be described with reference to the accompanying drawings in which

FIG. 1 is a fragmented perspective view showing a version of the non-woven sheet material constructed in accordance with the present invention and wherein an adhesive is deposited over the aluminized reflective surface and protected by a pressure release peel-off sheet;

FIG. 2 is a cross section view of the non-woven sheet material of the present invention;

FIG. 3 is a cross section view of a modified non-woven sheet material as illustrated in FIG. 1;

FIG. 4 is a section view showing an example of the application of the non-woven sheet material in a wall structure;

FIG. 5 is a cross section view showing a further application of the non-woven sheet material fabricated in accordance with FIG. 1 and utilized in a floor construction; and

FIG. 6 is a simplified diagram showing the method of fabricating the non-woven sheet material as illustrated in the cross section views of FIGS. 2 and 3.

### DESCRIPTION OF PREFERRED EMBODIMENTS

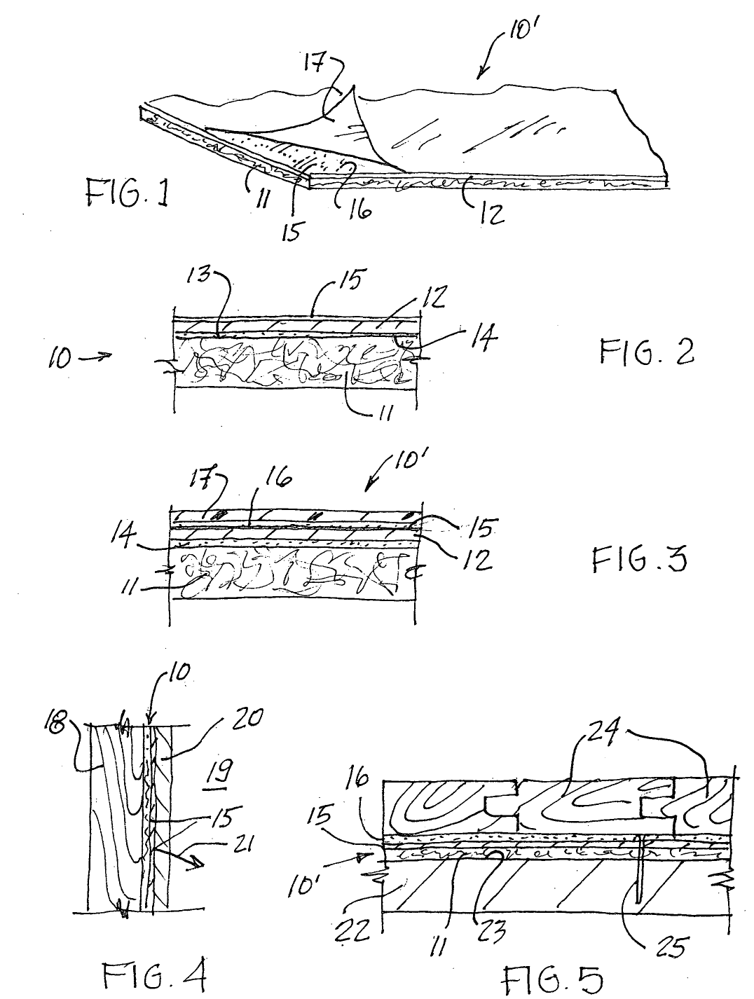

Referring now to the drawings and more particularly to FIGS. 1-3 there is shown generally at 10 and 10′ two versions of a non-woven sheet material constructed in accordance with the present invention and for use in building constructions as will be described later on. The non-woven sheet material 10, 10′ comprises, as better shown in FIG. 2, a non-woven felt 11 having a polymeric film secured over a surface 13 of the felt 11 by an adhesive layer 14. It is conceivable that the polymeric film could also be heat fused to the surface 13 of the felt.

The non-woven sheet material as herein illustrated has a weight density in the range of from about 30 to 1500 g/m² and a homogeneous mechanical integrity resistance to fragmentation by the application of traction forces applied thereto during its intended use.

The polymeric film 12 is further provided with an outer aluminized reflective surface coating 15 adhered thereto either by gluing or heat fusing. The polymeric film 12 may be a polyester film or a polypropylene or polyethylene film.

In the further embodiment of the non-woven sheet material 10′ as illustrated in FIGS. 1 and 3, there is provided an adhesive coating 16 over the aluminized reflective surface 15. A pressure release peel-off sheet 17, which is usually a transparent film sheet, is releasably attached to the adhesive coating 16 and can easily be peeled-off, as illustrated in FIG. 1, whereby to expose the adhesive 16 to provide attachment of the material to an object such as pipe, wall boards, floor boards, concrete floors and many other applications.

FIGS. 4 and 5 illustrate some of the applications of the non-woven sheet material 10 and 10′. As shown in FIG. 4 the non-woven sheet material 10 is secured to a vertical wall structure 18 with the aluminized reflective surface 15 facing inwardly of a space 19. A wall board 20 is secured over the non-woven sheet material. With this application the aluminized reflective surface provides heat reflective properties as illustrated by arrow 21 as well as providing a vapor barrier to the space 19. The felt material 11 provides acoustical and thermal properties to the space 19.

Referring to FIG. 5 there is shown a further application of the version of the non-woven sheet material 10′ as illustrated in FIGS. 1 and 3. In this application the non-woven sheet material 10′ is disposed over a floor covering 22 such as a plywood surface and with the felt 11 disposed against the upper surface 23 of the plywood sheet 22. The peel-off pressure adhesive sheet 17 is removed whereby to expose the adhesive surface 16. Floor coverings such as the tongue and groove boards 24 herein illustrated is disposed over the adhesive coating and adhered thereto. Other floor coverings such as tiles or floating floor material as is now commonly used, can also be applied to the adhesive surface 16. Accordingly, the use of fasteners or adhesive cement is not necessary and floor coverings can be installed very quickly. The non-woven sheet material 10′ or 10 as illustrated in FIGS. 4 and 5 can easily be secured to a support surface by staples such as illustrated at 25 in FIG. 5. Glue may also be used to attach the non-woven sheet material 10, 10′.

Although in the applications illustrated by FIGS. 4 and 5 the aluminized reflective surface faces inwardly of an enclosure space it can also be applied to face outwardly such as on a concrete floor in a basement of a building to act as a vapor barrier. It could also be disposed on ceilings and under floor carpets. There are several applications too numerous to mention but obvious to a person skilled in the art. It is also pointed out that the felt 11 could be fabricated with recycled fibers or viscose or other appropriate materials also obvious to a person skilled in the art.

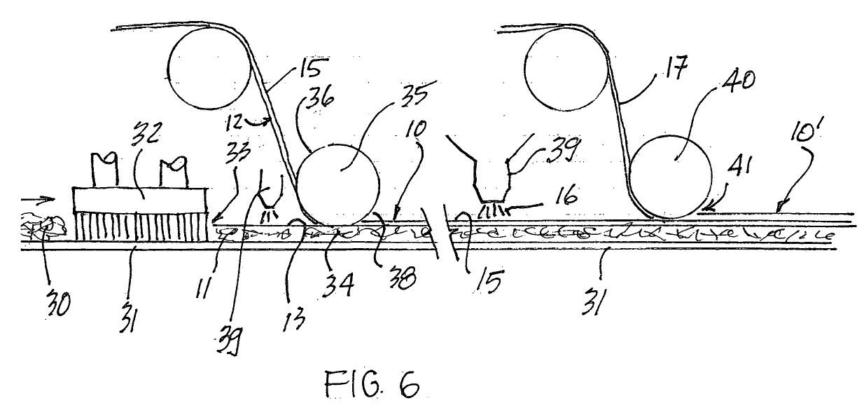

With reference now to FIG. 6 there will be described a preferred method of fabrication of the non-woven sheet material 10 and 10′. As hereinshown fibers 30 which may be polyethylene or polypropylene recycled fibers or viscose or the like are fed by a conveyor means, such as a belt conveyor 31 into a needling machine 32 whereby the fibers are intermingled to provide the felt 11 at its output 33. This felt 11 is transported by the conveyor 31 into a pressing gap 34 under a heated calender roll 35. The polymeric film material 12 is fed into the pressing gap and over the top surface 13 of the felt with the aluminized reflective surface 15 in contact with the outer surface 36 of the calender roll 35 whereby to heat fuse the polymeric film over the top surface 13 of the non-woven felt 11.

In a further embodiment glue may be sprayed over the top surface 13 of the felt 11 such as illustrated at 37 and the calender roll 35 could be replaced by a press roll whereby the polymeric sheet 12 is glued over the top surface 13. At the outlet 38 of the calender roll 35 the non-woven sheet material 10 of the present invention is produced.

As further illustrated in FIG. 6, in order to produce the non-woven sheet material 10′, as illustrated in FIGS. 1 and 3, the non-woven sheet material 10 is fed to an adhesive spraying head 39 which sprays the adhesive 16 over the top surface of the aluminized reflective surface 15. The non-woven sheet material 10 is then conveyed by the conveyor 31 under a press roll 40 under which is fed the pressure release peel-off sheet 17 and the composite non-woven sheet material 10′ is thus produced at the outlet 41 of the press roll 40.

It is within the ambit of the present invention to cover any obvious modifications of the preferred embodiment described herein providing such modifications fail within the scope of the appended claims.

1. A non-woven sheet material for use in building construction and having acoustical, thermal and waterproof properties, said sheet material comprising a non-woven felt having a polymeric film secured over a surface thereof, said polymeric film having an outer aluminized reflective surface coating adhered thereto, said sheet material having a weight density in the range of from about 30 to 1500 g/m² and a homogeneous mechanical integrity resistance to fragmentation by the application of traction forces applied thereto during its intended use, said sheet material capable of being used with said outer aluminized reflective surface facing upwardly or downwardly of an enclosure space to provide acoustical, thermal and an impervious barrier to humidity.

2. A non-woven sheet material as claimed in claim 1 wherein said polymeric film is one of polyester, polyethylene or polypropylene film.

3. A non-woven sheet material as claimed in claim 2 wherein said polymeric film is secured to a surface of said non-woven felt by an adhesive binder.

4. A non-woven sheet material as claimed in claim 3 wherein said polymeric film is heat bonded to said non-woven felt by a calender roll.

5. A non-woven sheet material as claimed in claim 2 wherein there is further provided an adhesive coating on said outer aluminized reflective surface, and a pressure release peel-off sheet releasably attached to said adhesive coating to protect said coating and to expose same upon removal of said pressure release peel-off sheet whereby to adhesively secure said non-woven sheet material to an object.

6. A non-woven sheet material as claimed in claim 1 wherein said non-woven sheet material is secured over a floor and in contact with a hard surface floor covering material such as wooden boards or tiles.

7. A non-woven sheet material as claimed in claim 5 wherein said non-woven sheet material is secured over a floor and with said adhesive coating in contact with a hard surface floor covering material such as boards or tiles to retain same over said floors.

8. A method of fabricating a non-woven sheet material for use in building constructions and having acoustical, thermal and waterproof properties, said method comprising the steps of:
i) needle punching fibrous material to form a non-woven felt sheet,
ii) transporting said non-woven felt sheet in a pressing gap under a heated calender roll, and
iii) feeding a polymeric film having an outer aluminized reflective surface coating in said pressing gap over a top surface of said non-woven felt with said aluminized reflective surface in contact with said calender roll to heat fuse said polymeric film over said top surface of said non-woven felt.

9. A method as claimed in claim 8 wherein after step (iii) there is further provided the step of (iv) applying an adhesive coating over a top surface of said aluminized reflective surface coating, and (v) applying a pressure-release peel-off sheet over said adhesive coating to protect said coating and to expose same upon removal of said pressure release peel-off sheet.
